(19) United States
(12) Patent Application Publication
(10) Pub. No.: US 2026/0153968 A1
(43) Pub. Date: Jun. 4, 2026

(54) DYNAMIC USER INTERFACE RENDERING ENGINE FOR PERSONALIZED DATA ACQUISITION USING INTELLIGENTLY CREATED RULES

(71) Applicant: PAYPAL, INC., San Jose, CA (US)

(72) Inventors: Savitha Ajitraj, Chennai (IN); Raghavendra Ravi Tej Moka, Dublin, CA (US); Lanny Mirawati, San Jose, CA (US)

(21) Appl. No.: 18/965,449

(22) Filed: Dec. 2, 2024

(51) Int. Cl. G06F 3/0481; G06Q 40/02

(52) U.S. Cl. CPC G06F 3/0481; G06Q 40/02

(57) ABSTRACT

There are provided systems and methods for a dynamic user interface rendering engine for personalized data acquisition using intelligently created rules. An online transaction processor or other service provider may provide computing services and platforms to entities including merchants for electronic transaction processing and other account services. To onboard entities with the transaction processor, the transaction processor may provide a merchant or user-specific experience and interfaces, which may be dynamically created and rendered based on available data for the merchant and required data to iterate through and process the onboarding. A rendering engine may intelligently synthesize rules for interface element selection for personalized data acquisition based on policies regarding required data and/or verification during onboarding. Using these rules and known data for the merchant, interface elements may be selected and used for interface creation and rendering to reduce user inputs and repetitive processing during onboarding.

### TECHNICAL FIELD

The present application generally relates to data acquisition through user interfaces (UIs), and more particularly to a rendering engine that dynamically creates and customizes user interfaces for data acquisition.

### BACKGROUND

Online service providers may offer various services to end users, merchants, and other entities. This may include providing electronic transaction processing data flows, services, and other computing resources. Further, the service provider may provide and/or facilitate the use of online merchant marketplaces and/or transaction processing between different entities. However, establishment and use of these digital services require merchants and other entities to onboard with the service providers. During onboarding operations, services may not be streamlined and users of these merchant or other entities may be required to engage with the same or similar UIs multiple times, including entering the same data and providing the same input that has previously been provided. The difficulties of properly onboarding such merchants and other entities may lead to poor user experiences (UXs), which may cause loss of customer reliance, data security issues, and/or attrition. Thus, there is a need to provide more streamlined and personalized UXs and UIs during onboarding while maintaining data security and efficiency for data entry when onboarding merchants, entities, and/or users for computing services with online service providers.

### BRIEF DESCRIPTION OF THE DRAWINGS

FIG. 1 is a block diagram of a networked system suitable for implementing the processes described herein, according to an embodiment;

FIGS. 2A-2C are exemplary diagrams for configuring dynamic user interfaces by a rendering engine based on rules for data acquisition and verification, according to an embodiment;

FIGS. 3A and 3B are exemplary user interfaces dynamically configured for a merchant based on known and available data with rules for data acquisition and verification, according to various embodiments;

FIG. 4 is a flowchart for a dynamic user interface rendering engine for personalized data acquisition using intelligently created rules, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a dynamic user interface (UI) rendering engine for personalized data acquisition using intelligently created rules. Systems suitable for practicing methods of the present disclosure are also provided.

To utilize the computing services of online service providers, such as electronic transaction processors that may provide merchants and customers with digital accounts for payment processing, users (e.g., individual customers or end users, as well as employees, owners, agents, etc., of merchants or other entities) may be required to onboard with the service providers. During onboarding operations, services may not be streamlined to prevent users from performing unnecessary data input and/or engaging in duplicate activities, which creates duplications of data and processing requests and unnecessarily burdens users with repetitive inputs and unnecessary UI flows. Since conventional onboarding processing provides static UIs and user experiences (UXs), users become burdened with additional manual inputs and wasted time, which may also impact computing systems by storing duplicate data and/or executing repeated processing tasks and operations when those have previously been performed.

Onboarding is typically needed before users, including merchants or customers, can process transactions, such as for a payment to another user or a transfer, through an online service provider. The user may request processing of one or more transactions using a digital wallet or other account with the online service provider or transaction processor (e.g., PayPal®), which may require onboarding for such accounts, as well as for user and merchant services, financial instruments, and the like. In order for merchants to provide services for users to engage in these processes and interactions for processing transactions with the merchants, the service provider may provide operations for merchants to onboard and setup merchant payment accounts and transaction processing operations and procedures through one or more merchant websites, systems, applications, devices, and the like. For example, when accessing online platforms and utilizing the corresponding computing resources of a service provider, such as the aforementioned transaction processor, merchants may onboard with the service provider to obtain access to accounts and computing services and utilize corresponding services during the course of business or other interactions with customers, clients, and/or entities. The merchant onboarding experience is often a time consuming and difficult process requiring many data inputs, uploads, computing service setups (including software development kit (SDK) usage and setup), application and/or website setup and configuration, and the like. This may result in merchants dropping off from a service provider's onboarding platform, account setup, and/or computing service usage.

Further, merchants may utilize incorrect computing services or may not engage with computing services that may be valuable and beneficial to the merchant. Gaps from integration, complex workflows, and processes that create tension and friction with onboarding of accounts and services may lead to loss of merchant onboarding and/or poor user experiences (UXs) of the merchants. Further, there may be an unfriendly merchant experience. For example, recommended actions, pathways, and/or flows for maximum benefit and/or efficient onboarding are not always clear and not specific to the merchant or other entity. The service provider may want to provide an in-context experience with a latest SDK implementation, which may not provide operations and redirects for interface-specific and/or tightly controlled interface elements, such as interface buttons that may be controlled by specific data processing policies and operations. Further, the service provider may be requesting too large of an amount of information that may be unnecessary for onboarding compliance, including exposure of sensitive data that is not needed for onboarding. Additionally, complexities may arise during onboarding of merchants including cluttered or overwhelming options and interfaces, confusion about integration(s) that should be used by specific merchants and/or requirements for computing services, and/or lack of personalized recommendations and/or identification of actions for merchants to take that may enhance either business and/or create more efficient or optimized use of the service provider by the merchant during or after onboarding. Such issues may especially be important with computing devices having smaller UIs, such as phones and watches, which may then result in very dense content and/or multiple screens that are needed to go through the UX.

While conventional onboarding UIs and UXs may be cumbersome and time consuming, without detailed or personalized instructions, a service provider may provide a dynamic and customized onboarding experience through a dynamic UI rendering engine that may customize UI presentation, data entry, and the like based on known, verified, and/or authenticated information for a merchant. For example, trusted merchants of an online transaction processor (e.g., those merchants that utilize the online transaction processor for electronic transaction processing and have been verified and trusted based on past experiences, usage, risk analysis, etc.), may have previously provided information to the merchant and/or engaged in an initial onboarding process for a computing service. When engaging in a conventional onboarding process, the merchant may be required to provide already submitted information and/or proceed through a re-onboarding process to avail themselves of new services, which creates friction and drop off. However, risk teams have identified these trusted merchants who can be preapproved based on their history and risk behavior. As such, the merchant may not be required to resubmit known and/or verified information.

The merchants may also continue to stay eligible for a length of time, such as 90 days after an initial verification and/or risk analysis. As such, there may not be a need for the merchants to go through the re-onboarding experience, and instead the merchants may proceed through a rapid onboarding process to quickly engage in and use the new services. However, certain regulatory requirements, processing models, and the like may require certain data and/or updates of known data for properly onboarding and/or service provision. However, with current static UIs and general data entry requests, there is no process by which merchants may have their onboarding experience or other UX personalized and customized for the requisite data acquisition, thereby minimizing unnecessary inputs. As such, the dynamic UI rendering engine may customize and personalize UIs for data acquisition based on intelligently created rules for a more streamlined, faster, and predictive process to onboard users.

In various embodiments, an online transaction processor or other service provider may make the merchant experience onboarding more friendly, efficient, and personalized, without unnecessary exposure of sensitive data, using a conversational artificial intelligence (AI) engine and model(s) with an intelligent chat assistant. For example, the service provider may provide resources for onboarding based on a determined recommendation for a computing service or other product offered by the service provider to the merchant. In this regard, an AI engine and system may include one or more AI models, such as machine learning (ML) models, neural networks (NNs), or the like, to determine a personalized and recommended UI and UX for onboarding of a computing services offered to merchants or other users, entities, and the like based on what may be beneficial and/or assistive for the merchant's history, tasks, requirements, or the like. This may be done through a rule synthesis of rules used to dynamically configure UIs, as well as real-time usage of the rules to configure UIs for personalized UXs during onboarding.

Training of the AI may be performed using background data for the service provider and/or merchants of the service provider, such as the available computing services and/or products of the service provider, onboarding success and/or use of the computing services. Further, past onboarding experiences, experience feedback, and/or use or engagement with computing services, products, and the like of the service provider by merchants during or after onboarding may be used for training data. During training of an AI model, the model may be trained to make predictions and recommendations, as well as other guidance, for a merchant or other entity when onboarding. One important aspect is that the service provider may be requesting too large of an amount of information that may be unnecessary for onboarding compliance, including request of data reentry that is not needed for onboarding. In various embodiments, the service provider may make the merchant experience onboarding more friendly, efficient, and personalized, without unnecessary exposure of sensitive data, using dynamically rendered UIs that perform personalize data acquisition from customized and intelligently created rules for UI presentation and rendering.

Rules for dynamic UI customization may be generated and/or synthesized from regulatory requirements for onboarding (e.g., laws, rules, and/or regulations), internal teams (e.g., risk, compliance, underwriting, etc.), and the like. The rules may also be generated based on knowledge of successful and/or optimized or efficient onboarding processes and UXs. As such, the rules may be generated to create, in real-time and during user onboarding or other UI engagement, UIs that dynamically change, alter, and/or provide elements, features, and data for a personalized UX. In this regard, an enhanced onboarding platform (EOP) may provide a system and framework where policies for different products, computing services, and/or requirements of the service provider as used as input to a rule generation and synthesis engine that intelligently generates rules that dictate, drive, or configure the customizable UI elements that may be displayed to a merchant or other entity during an onboarding and/or enrollment process for a product and/or computing service, such as use of an account, engagement and/or enrollment with a service product (e.g., mobile payments), and the like.

The rules may be intelligently generated using an AI engine based on different policy repositories, and the rules may be stored for use with dynamic UI rendering. As such, when a merchant enters an onboarding flow, a real-time analysis may be performed of known, previously provided, and/or available information for the merchant, including input by the merchant, risk analysis of the merchant, past uses of products and/or other past engagements, and the like. This analysis may indicate, based on the rules, the requirements to onboard the merchant, such as the additional data that the merchant is required to provide, enter, or input to the onboarding flow and/or via one or more UIs. The rules may drive which corresponding UI elements (e.g., from customizable UI elements available for UI presentation) are presented to the merchant to obtain that required data, as well as how the customizable UI elements are presented to the user. As such, a dynamic UI rendering engine may utilize the rules to create a dynamic UI having those particular elements, as well as any pre-completed elements and inputs from the available information, which may be rendered to the merchant on a corresponding device. Thus, the rules allow for a determination of what data is required and what data may be omitted from those that normally would be required from a merchant in a standardized and generic UI and/or during the UX for the standardized onboarding process, thereby limiting or preventing the merchant from reentering previously provided information and/or going through unnecessary onboarding steps.

Using these rules once generated and/or synthesized from regulations, requirements, onboarding flows, etc., the service provider may provide an enhanced onboarding platform (EOP) with a “one-click” functionality to onboard users, where “one-click” generally refers to a single or limited number of user inputs during the UX and/or in the UIs of the UX for merchant (or other user/entity) onboarding. For example, the EOP may dynamically configure UIs of the UX for onboarding where known information for the merchant, user, or other entity is automatically entered to the onboarding process and/or with UIs in the onboarding flow and UX. This allows for a dynamic UI rendering engine of the EOP to create a UI with corresponding UI elements, as well as dynamically render the UI during the onboarding flow and UX, that are configured to streamline and personalize the onboarding experience. For example, with high-value merchants or other entities that may previously have engaged with the service provider, significant portions of data may be known, verified, and risk/underwriting may previously have been run and authorized.

The EOP may also prefill information for each regional account based on existing data, which provides tailored content, and offers step-by-step guidance, enabling quick and efficient onboarding. As such, the EOP may gather data from trusted sources for dynamic UI customization and rendering, thereby tailoring the onboarding flow to the merchants' needs and providing clear guidance for onboarding with minimal friction and repetitive processes. This further allows for onboarding of merchants quickly and efficiently, ensuring that each merchant has a tailored and guided onboarding experience, reducing friction and improving activation rates.

As such, the EOP delivers a simpler, faster, and more tailored onboarding process by pre-filling information, providing step-by-step guidance, and allowing easy provisioning of multiple products. The EOP may significantly improve the merchant (or other entity) experience and operational efficiency during onboarding. For example, with conventional onboarding processes, UIs are static and do not adapt based on merchant behavior or performance. This leads to inefficiencies and delays, as every merchant undergoes the same process regardless of their history or trustworthiness. In contrast, the EOP dynamically refreshes and evaluates merchants that can be trusted based on their performance, past history, and/or known information. The real-time adjustment ensures that reliable merchants or other entities may be fast-tracked, reducing onboarding time and improving satisfaction.

Further, existing platforms often struggle with scalability, particularly when handling different products with varying eligibility criteria. This results in a one-size-fits-all approach that does not cater to the specific needs of different products in order to comply with computational demands and availability of computing services. However, the EOP may be scalable and accommodate the unique eligibility criteria of different products for different merchants. The platform may use a batch consumer product as input and dynamically assess the eligibility criteria for each product. This scalability ensures a tailored and efficient onboarding process for all products. In contrast, conventional onboarding systems do not have a sophisticated method for pre-verifying merchants before they apply for a product, leading to increased risk and potential fraud. In contrast, the EOP may incorporate trust and risk algorithms from an intelligent risk system, which may compute risk, trust, and authorization of merchant data and/or for service provision prior to UI rendering for data acquisition from merchants. This algorithm evaluates merchants based on their risk performance and history and verifies merchants even before they apply for a product, ensuring trustworthy merchants are fast-tracked through the onboarding process. This proactive risk assessment reduces fraud, enhances security, and builds a more reliable merchant network.

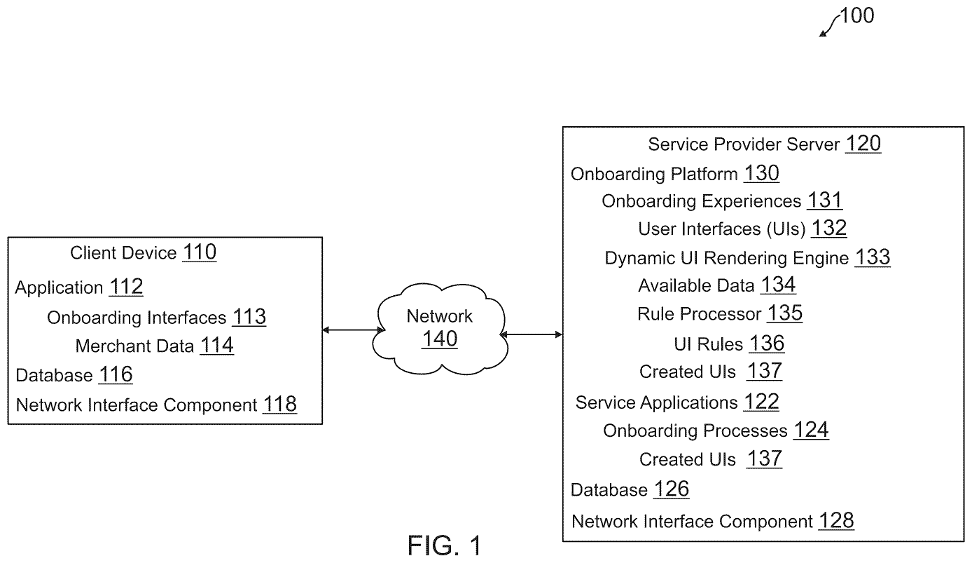

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by a merchant or other user to receive communications over network 140, where service provider server 120 may provide various data, operations, and other functions over network 140 to provide services to merchants, users, and computing devices. In this regard, client device 110 may be used to onboard with service provider server 120. Service provider server 120 may provide streamlined and personalized operations for onboarding interfaces, operations, and UXs through dynamically customized and rendered UIs using rules for data acquisition, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

In some embodiments, application 112 may correspond to one or more processes to execute software modules and associated components of client device 110 to provide features, services, and other operations by a merchant for consumers over network 140, which may include merchant sales operations, POS device processing and/or operations, online merchant marketplaces, sales and inventory services, and the like. Further, application 112 may enable requesting and onboarding with service provider server 120 for use of a merchant account, payment and/or electronic transaction processing services, and other computing services provided through onboarding interfaces 113. In some embodiments, this may further include processes for merchant sales, inventory, return or exchange, risk analysis, and other services a merchant may require during the course of their business and sales. In this regard, application 112 may correspond to specialized software utilized by a merchant (e.g., as an entity) and/or a corresponding user of the merchant to access and/or utilize an account and/or computing services through merchant onboarding with service provider server 120. Application 112 may provide and/or process items for sale with client device 110 and/or a user interacting with client device 110 (e.g., using a POS device, the website, mobile application, or another merchant marketplace platform). In certain examples, application 112 may be accessible over the Internet and provide for sales with client device 110 over network 140.

In some embodiments, application 112 may correspond to and/or be used to configure a checkout application at a physical merchant location, such as the application(s) of a point-of-sale (POS) device used to provide sales at physical locations. For example, application 112 may be used to establish a transaction once a user/employee associated with client device 110 has selected one or more items for purchase and/or entered the item(s) to the transaction for processing. Once a payment amount is determined for the item(s) to be purchased by the user, application 112 may request payment for the transaction. Payment may be provided using electronic transaction processing services enabled and/or provided by service provider server 120 after merchant onboarding using personalized UIs through an onboarding UX, as discussed herein. In this regard, payment may be received from a user and may be processed using service provider server 120. After receipt of payment and/or confirmation of the payment, application 112 may then process a payment to the merchant associated with client device 110.

In some embodiments, client device 110 may be used to host, provide, and/or access and maintain a website of the merchant, a web-based application, data for native or resident software applications on devices (e.g., mobile applications), or the like. However, in other embodiments, client devices 110 may instead be a device of an employee, owner, agent, or other user associated with a merchant, and may allow that user to perform onboarding for computing services of service provider server 120 on behalf of that merchant. As such, client device 110 may instead be used for accessing and utilizing websites and/or applications of service provider server 120 to engage use of computing services, onboard for those services, and the like on behalf of a corresponding merchant. Further, although client device 110 is described as being associated with and/or utilized by a merchant and/or user associated with a merchant for merchant onboarding, in other embodiments, other types of users, such as customers, individuals and end users, and the like may use client device 110 in a similar manner to onboard for their corresponding processes, accounts, and/or computing services, and as such, the processes to dynamically configure and render UIs for onboarding on client device 110, as described herein, may not necessarily be associated with merchants and sales, and instead be applicable to any such digital onboarding process provided through a digital UX and UIs.

In this regard, service provider server 120 may streamline onboarding operations, such as by providing onboarding interfaces 113 having UI capabilities and layouts customized based on merchant data 114. Application 112 may be used to request and/or enter an onboarding flow, such as a data processing flow through a UX that may be used to onboard a merchant and/or user for use of a product, service, account, or the like that may be provided by service provider server 120 (e.g., through an account establishment process or enrollment process). Merchant data 114 may include previously provided data to service provider server 120, such as data that may be provided during previous onboarding and/or through use of service provider server 120. However, merchant data 114 may also include data required for onboarding, which needs to be provided through onboarding interfaces 113 during the onboarding process. As such, service provider server 120 may customize onboarding interfaces 113 dynamically using a rendering engine to request specifically the portions of merchant data 114 needed for onboarding, while using previously received and preexisting portions of merchant data 114 acquired by service provider server 120 to verify the merchant, preload merchant data 114 to one or more fields of onboarding interfaces 113 and/or eliminate those fields from display, and otherwise customize onboarding interfaces 113 and the corresponding UX for a streamlined onboarding process.

Application 112 may correspond to a general browser application and/or general, native, or local software application including mobile applications that may be configured to retrieve, present, and communicate information over the Internet (e.g., utilize resources on the World Wide Web) or a private network. For example, application 112 may provide a web browser, which may send and receive information over network 140, including retrieving website information (e.g., a website for an email provider or other messaging service), presenting the website information to the user, and/or communicating information to the website. Application 112 may include a dedicated application provided by service provider server 120. Application 112 may be associated with digital payment accounts, account information, user financial information, and/or transaction histories, which may be associated with electronic transaction processing services provided by service provider server 120 for merchants.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may require onboarding for account and service usage through the use of dynamically created and rendered UIs for data acquisition based on synthesized rules associated with UI presentations and outputs. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes and/or is associated with an onboarding platform 130, service applications 122, a database 126, and a network interface component 128, implementations of which are discussed further below. Onboarding platform 130 and service applications 122 may correspond to executable processes, procedures, and/or applications with associated hardware. In other embodiments, service provider server 120 may include additional or different modules having specialized hardware and/or software as required.

Onboarding platform 130 may correspond to one or more processes to execute modules and associated specialized hardware of service provider server 120 to provide a personalized onboarding experience and UIs for onboarding of merchants, customers, and/or other users or entities with online data platforms, services, and products provided by or associated with service provider server 120. In this regard, onboarding platform 130 may correspond to specialized hardware and/or software used by a merchant or other user associated with client device 110 to provide operations for onboarding of a merchant or customer for an account or computing service usage with service provider server 120, as well as maintenance of such accounts and services over time. For example, onboarding platform 130 may be used to specifically configure onboarding experiences 131 having UIs 132 based on known and required data so that onboarding experiences 131, such as a UX provided through one or more flows, may be specifically tailored to the individual user or a merchant or other entity, represented by a user, based on their trust profile and/or risk analysis, known and/or preexisting data, and required data for onboarding of the computing service, product, or the like. UIs 132 may correspond to a flow or navigation through multiple interfaces and processes, which may correspond to the data processing flow of the corresponding onboarding process and experience. As such, onboarding experiences 131 having UIs 132, as specifically onboarding processes 124 provided through service applications using onboarding experiences 131 having UIs 132, may have an iterative process or nature where data is iteratively entered and/or provided to complete or process an onboarding of a merchant or user.

In this regard, onboarding platform 130 may receive requests for onboarding and/or generation of a personalization of onboarding experiences 131 through UIs 132 from a merchant, internal team or user (e.g., a sales team or representative, advertising, etc.), customer, or the like. For example, with merchants, the request may be based on running or processing a risk analysis and/or trust rating of the merchant and determining a computing service or other product of potential interest, upselling, and/or use to the merchant. Merchant characteristics may be used to determine this analysis and/or rating. A trust model may be used to determine a risk and/or trust profile, and the profile may be changed or updated over time as one or more characteristics of the merchant change or are updated. The merchant, customer, or other entity/user characteristics may be associated with the merchant's business, business value, business information, trust and/or historical risk, underwriting, and the like. For example, the characteristics may be associated with historical information for the merchant, such as historical value information for an account of the merchant. As such, offers for onboarding and their corresponding processes may be provided based on characteristics of the merchant, user or the like.

Onboarding experiences 131 may correspond to UXs for an onboarding and/or data processing flow that may acquire and process data, such as user or merchant data, to determine a user's and/or merchant's eligibility to onboard and access, receive, and/or use a computing service or product of a service provider corresponding to service provider server 120. In this regard, onboarding experiences 131 may be customizable and dynamically configured for the user and/or merchant of a corresponding onboarding process and experience, such as the one that will be provided to the user and/or merchant (e.g., through an employee, owner, agent, or other user via client device 110) when that user and/or merchant engages in the onboarding process and/or progresses through UIs 132, flows, and data acquisition requests of UIs 132. To provide this more personalized experience, UIs 132 may be configured dynamically by dynamic UI rendering engine 133 based on rules, known or preexisting data for the merchant and/or user, required data for acquisition during the onboarding process. UIs 132 may include one or more UI elements, or such UI elements may be available from a buildable component factory of UI elements and the like for creation of UIs 132, and each of those UI elements may be dynamically configured and/or usable for the requisite data acquisition task, requirement, or iterative process during onboarding of a merchant or user. As such, layouts of UIs 132 may be changed, customized, and/or built using UI elements, such as data entry fields, menus, informational fields, options, navigation tools or links, and the like.

Dynamic UI rendering engine 133 may correspond a processor, one or more AI models, and additional components as necessary to create and synthesize rules for data acquisition and pre-validation and/or pre-verification of merchants and/or users for onboarding experiences 131, which may be used to dynamically customize and configure UIs 132 based on their corresponding UI elements for data acquisition tasks or requirements. Available data 134 may include merchant-specific data that may have been previously acquired and/or generated or may otherwise preexist with service provider server 120 or is accessible to service provider server 120. As such, available data 134 may be used to personalize the UX and UIs 132 using an AI engine and models, which may dynamically configure the UI elements based on pre-approval and/or pre-verification for certain onboarding data acquisition requirements and the additional requirements for onboarding. Dynamic UI rendering engine 133 includes a rule processor 135 that may synthesize UI rules 136 for customization and dynamic creation/rendering of UIs 132. Rule processor 135 may execute an AI engine to synthesize rules from policies of the service provider associated with service provider server 120 and/or other laws, rules, and/or regulations that may be followed or required by policy for data acquisition and/or onboarding (e.g., for trust, risk, fraud, identification and/or authentication, etc.). Policies may therefore include a risk management policy, a product usage policy, or a legal compliance policy. These policies may be associated with data collection requirements and may be stored in a policy repository or other database, where the policies may be managed for the services available for onboarding. UI rules 136 may be created for verification of data variables used for merchant authorizations to onboard with and/or use the services and may also be associated with merchant behaviors or past histories that indicate requirements for data acquisition.

It may be determined that a merchant is performing an onboarding for a merchant account or product or may be offered an onboarding process and/or product of service provider server 120. Based on available data 134 and UI rules 136, created UIs 137 may be generated dynamically by dynamic UI rendering engine 133. Dynamic UI rendering engine 133 may generate created UIs 137 using one or more AI engines, for example, using an ML or other AI model. Created UIs 137 may allow for iterative data entry and processing through onboarding experiences 131 having UIs 132 that have been customized and tailored for a specific merchant. Created UIs 137 may correspond to a UI and UI layout that has been generated, customized, and/or may be dynamically rendered with a particular layout as determined by one or more ML or AI models of dynamic UI rendering engine 133 based on the rules synthesized by rule processor 135

An AI engine for dynamic UI rendering engine 133 and/or rule processor 135 may include one or more AI or ML models, NNs, conversational AIs, or the like. AI models may have trained layers based on training data and selected features or data variables configured for onboarding processes 124 and/or onboarding experiences 131, as well as UIs 132. For example, ML features or variables may correspond to individual pieces, properties, characteristics, or other inputs for an ML model and may be used to cause an output by that ML model once the ML model has been trained using data for those features from training data. AI models may be used for computation and calculation of model scores based on layers, nodes, branches, clusters, rules, and the like that are trained and optimized. As such, ML models may be trained to provide a predictive output, such as a score, likelihood, probability, or decision, associated with a particular prediction, classification, or categorization.

AI models may include DNNs, MLs, LLMs, generative AIs, or other AI models trained using training data having data records that have columns or other data representations and stored data values (e.g., in rows for the data tables having feature columns) for the features. When building AI models, training data may be used to generate one or more classifiers and provide recommendations, predictions, or other outputs based on those classifications and an ML or NN model algorithm and architecture. The algorithm and architecture for the AI models may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the AI models are used to perform a predictive analysis and output, the input data may provide a corresponding output based on the trained classifications.

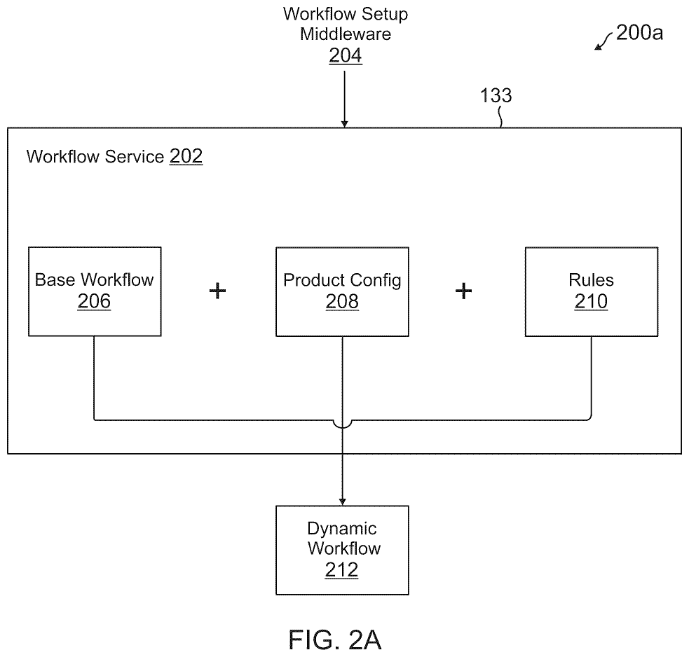

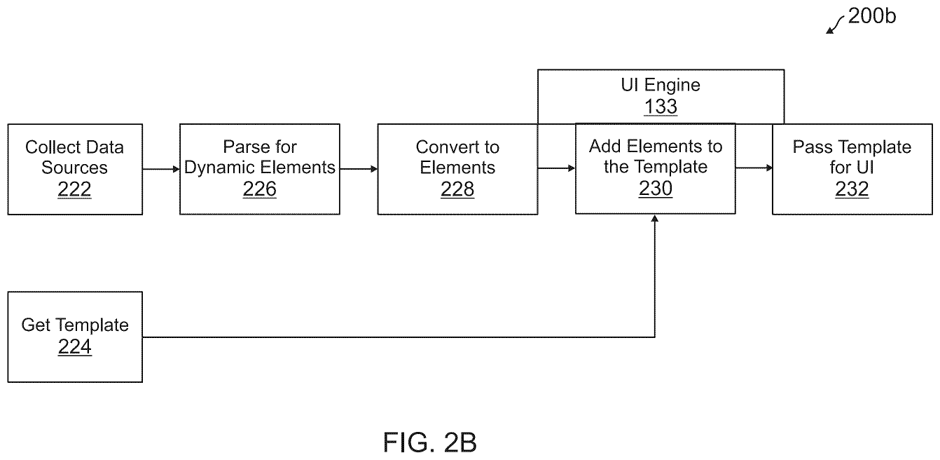

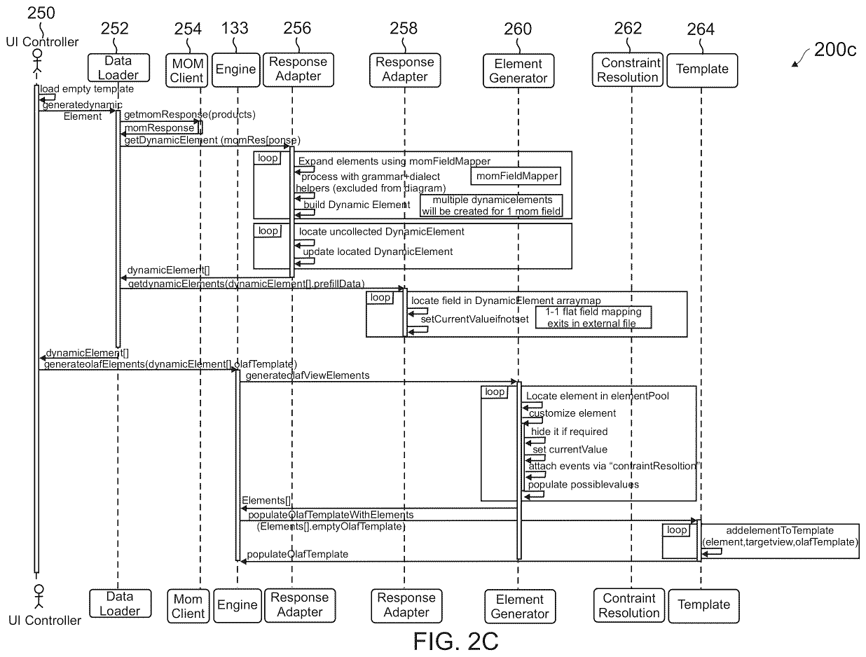

Layers, branches, clusters, or the like of the AI models may be trained by using training data associated with data records of interest, such as onboarding options, computing services, personalized assistance responses, available and/or required data for onboarding tasks and goals, and the like. By providing training data, the nodes in the hidden layer may be trained (adjusted) such that an optimal output (e.g., a classification) is produced in the output layer based on the training data. By continuously providing different sets of training data and/or penalizing the AI models when the outputs are incorrect, the AI models (and specifically, the representations of the nodes in the hidden layer) may be trained (adjusted) to improve its performance in data classifications and predictions. Adjusting of the AI models may include adjusting the weights associated with each node in the hidden layer. The operations for intelligent rule synthesis and use in dynamic UI rendering for data acquisition are discussed in further detail with regard to FIGS. 2A-4 below.

Service applications 122 may correspond to one or more processes to execute modules and associated specialized hardware of service provider server 120 to process a transaction and/or provide other computing services to users. For example, service applications 122 may include a transaction processing application used to process payments and other services to one or more users, merchants, and/or other entities for transactions, where merchants may onboard for use of the transaction processing application through onboarding processes 124, such as to establish merchant accounts and/or request use and/or engagement with a computing service or other product offered by a service provider corresponding to service provider server 120. For example, an account establishment process for an account may be used to send and receive payments, including those payments that may be enabled through the merchant's website, application, POS devices, and the like after merchant onboarding. A merchant payment account may be accessed and/or used through a browser application and/or dedicated payment application executed by client device 110, such a payment and/or digital wallet application. The transaction processing application may process payments and may provide transaction histories to client device 110 and/or another user's device or account for transaction authorization, approval, or denial of the transaction for placement and/or release of the funds, including transfer of the funds between accounts.

Further, service applications 122 may provide different computing services, including social networking, microblogging, media sharing, messaging, business and consumer platforms, etc. These computing services may be used by merchants, customers, and other users or entities, where onboarding for use may be performed through onboarding processes 124. As discussed herein, onboarding processes 124 may be iterated through and/or advanced based on different UIs including created UIs 137, where created UIs 137 may be customized by dynamic UI rendering engine 133 based on known and/or preexisting data, onboarding processes and data requirements, and rules for data acquisition and processing for onboarding. As such, service applications 122 may present one or more of created UIs 137 when users and their corresponding devices engage with onboarding processes 124.

Service applications 122 further may provide additional features to service provider server 120 for internal and/or external applications, websites, systems, processors, and the like. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 126. Database 126 may store various identifiers associated with client device 110 and/or other devices and/or servers that may engage and/or interact with accounts, computing services, and/or onboarding processes 124. Database 126 may also store account data, including payment instruments, financial information, account balances, and authentication credentials, as well as transaction processing histories and data for processed transactions. Database 126 may include information used during merchant onboarding. Although database 126 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate with client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2C are exemplary diagrams 200a-200c for configuring dynamic user interfaces by a rendering engine based on rules for data acquisition and verification, according to an embodiment. Diagrams 200a-c may include components of service provider server 120 that may be utilized for dynamic UI creation for data acquisition during onboarding of a merchant account and/or use of a computing service, as discussed in reference to system 100 of FIG. 1. In this regard, diagrams 200a-c may represent the interactions, flow, and execution of calls between such components when determining UI elements and different UI layouts for data acquisition based on known or available data and required data for merchant onboarding.

Referring now to diagram 200a of FIG. 2A, dynamic UI rendering engine 133 may be initiated and/or engaged in order to configure and create one or more UIs utilized for data acquisition during onboarding of an entity or user, such as a merchant or customer, for a computing service, product, account, or the like of a service provider. As such, dynamic UI rendering engine 133 may determine UI elements and a UI layout of such elements to present to a user during the onboarding UX in place of standardized or generic UIs as may be accessed by an unknown or anonymous user. In contrast to these generic UIs, dynamic UI rendering engine 133 may create a UI that is customized to avoid and minimize repetitive onboarding processes and inputs, such that a streamlined and efficient onboarding process may be provided. As such, onboarding platform 130 may determine that a merchant, user, or the like is eligible for onboarding for the corresponding product and/or has accessible, known, and/or preexisting data that enables at least some steps or portions of the onboarding process to be preapproved and/or preauthorized using such data. As such, these steps may be automatically completed and/or processed instead of being iterated through during onboarding, which may cause user friction. Dynamic UI rendering engine 133 may receive a request for an onboarding UI from a workflow setup middleware 204 of onboarding platform 130, which may be a predictive UI generation request for an eligible product for the merchant or user or determined in real-time as the merchant or user engages with the onboarding process.

Workflow setup middleware 204 may correspond to a middleware application (e.g., software that may connect applications distributed among systems and platforms, such as the different components of onboarding platform 130). Workflow setup middleware 204 may handle the request from service applications 122 for dynamic UI creation and rendering for onboarding processes 124. Dynamic UI rendering engine 133 may receive the request from workflow setup middleware 204 and utilize a workflow service 202 that may include an AI engine, one or more AI models (e.g., ML models, NNs, LLMs, etc.) and/or UI rendering engine to customize UI element layout and presentation.

A base workflow 206 may be accessed for the onboarding process by workflow service 202 of dynamic UI rendering engine 133. Base workflow 206 may correspond to a generic workflow, such as a data processing flow that is iterated through and/or advanced for portions of data requested and acquired for onboarding, without customization based on available data and rules for UI customization based on data acquisition policies. To customize base workflow 206, the AI engine of dynamic UI rendering engine 133 used by workflow service 202 may determine a product configuration 208 of the onboarding process for data acquisition in order to onboard for use of the corresponding product. The AI engine may utilize the known, preexisting, and/or available data for the merchant or user with rules 210 for data acquisition and onboarding for the product to determine a set of UI elements that may be used to acquire the necessary data, while eliminating data acquisition UI elements and iterative data entry portions for unnecessary and/or preapproved portions of the onboarding process.

Rules 210 may be previously determined using one or more AI models of dynamic UI rendering engine 133, such as an ML model trained for rule synthesis and output (e.g., an LLM or other generative AI) based on the policies of the service provider. As such, by using product configuration 208 with rules 210, base workflow 206 may be dynamically changed, updated, reconfigured, and/or used to create a new workflow, a dynamic workflow 212 for a dynamically rendered UI. Dynamic workflow 212 may therefore change and update a processing flow to proceed through the required data acquisition processes using corresponding UI elements while eliminating or reducing unnecessary processes and UI elements.

Referring now to diagram 200b of FIG. 2B, preprocessing of inputs to dynamic UI rendering engine 133 is shown with corresponding data processing and outputs for dynamically configured UIs. Initially, data sources 222 are collected, such as those that may be used for product configuration 208. Data sources 222 may include available data 134 and/or other data that may indicate what information is required and what information can be preauthorized and/or prefilled in an onboarding experience and/or UIs. For example, data sources 222 may include preexisting, known, or available merchant data that does not require reentry and/or can be preauthorized. When onboarding is requested and/or offered, a template 224 is also obtained, which may be configured specifically for data sources 222 to personalize template 224. In this regard, template 224 may correspond to a generic and/or template UI layout, such as a template layout and/or template workflow for a presentation of a UI, which may be configured based on UI elements for the UI and/or data acquisition and verification processes performed during onboarding.

Prior to dynamic UI rendering engine 133 configuring template 224, dynamic elements 226 are parsed from data sources 222, such as by parsing data sources 222 to determine which dynamic elements can be preauthorized and eliminated or reduced, and which dynamic elements may be required to be configured in a UI for data acquisition. Data sources 222 may indicate what data is available and what may be required to be received, updated, and/or confirmed. In this regard, dynamic elements 226 may also be determined based on rules for UI element presentation for acquiring data during onboarding processes. Dynamic UI rendering engine 133 may utilize dynamic elements 226 to perform an element conversion 228 to configure dynamic elements 226 for template 224 so that the UI elements necessary for data acquisition may be used and provided in a UI layout, while those that are unnecessary or have been preauthorized are eliminated or have their input automatically entered for review, confirmation and the like.

As such, element conversion 228 by dynamic UI rendering engine 133 may change, update, remove, and/or enter input and data into one or more of dynamic elements 226. Template 224 may then be accessed and used by dynamic UI rendering engine 133 to create a UI having a UI layout of dynamic elements 226 after element conversion 228. A template configuration may update template 224 to include those of dynamic elements 226 from element conversion 228, which have been added to template 224. Dynamic UI rendering engine 133 may then pass an updated UI template 232 after rendering to a client device for display via a UI.

Referring now to diagram 200c of FIG. 2C, a controller 250 may initially load a template, which may have dynamic UI elements configurable and/or usable with the template for configuring a UI corresponding to the template. Diagram 200c represents exemplary API calls, such as API requests and responses, from the components of and/or utilized by onboarding platform 130 for UI configurations during onboarding. Controller 250 may engage with a data loader 252 to generate those dynamic elements for the template and presentation in a layout of the UI. In this regard, data loader 252 may make a request to a message-oriented middleware (MOM) client 254 for a MOM response of the product, service, account, or the like for the onboarding processes, and MOM client 254 may respond with information indicating the type and/or purpose of UI elements needed for data acquisition during the onboard process.

Data loader 252 may provide information to a response adapter 256 regarding the product being onboarded for and/or being offered for onboarding to the merchant or other user/entity. Response adapter 256 may adapt and configure the information specifically for each collected or uncollected element's data field in a UI for an onboarding experience and processing flow. For example, for each uncollected field, response adapter 256 may loop through the UI element to expand the element using a field mapper including generating a JSON object or file for response field adaptation in UIs, process with grammar and/or dialect helpers for the merchant and/or context of onboarding the merchant (e.g., location, region, language, etc.), and build a dynamic element for a UI that may be dynamically provided in a layout of the UI. For those collected fields where data may already be known, collected, or obtained, the corresponding dynamic elements may be located and updated with the data, which obviates and removes their need for display and output in the layout of the UI when dynamically configured.

Response adapter 256 may respond to data loader 252 for the engine with the dynamic elements. Data loader 252 may then call another response adapter 258 that may adapt prefill elements within the UI, which may show and present data to a user during the onboarding and in the dynamically configured UI. As such, response adapter 258 may locate a corresponding field for the element and may set a value of the field to the current value of the known data if not already set. Response adapter 258 may provide the prefilled dynamic element to data loader 252, which may then respond to and provide the dynamic elements back to controller 250 for further handling and processing during dynamic rendering of the UI using a layout of the UI elements.

Controller 250 may then generate a template with the dynamic elements using dynamic UI rendering engine 133 by providing the template and dynamic elements to dynamic UI rendering engine 133 for processing. Using the template and elements, dynamic UI rendering engine 133 may generate a view of the elements with an element generator 260 by looping through each dynamic element for UI population in a layout. For example, element generator 260 may locate an element in the element pool, customize the element for the layout including hiding the element if required, and setting a current value. Element generator 260 may attach events via a constraint resolution requirement to dynamic elements for a requirement and/or execution of those events to occur for element rendering and/or use (e.g., advancing through elements during an iterative data entry process for merchant onboarding). Finally, element generator 260 may populate possible values for selection by the user, such as suggested or potential values for certain menu options, field entries, and the like.

Thereafter, element generator 260 may provide the view of the elements, such as a layout of elements in a UI, for the template back to dynamic UI rendering engine 133. Using this view, dynamic UI rendering engine 133 may populate the template with the elements for rendering during a merchant onboarding experience. In this regard, dynamic UI rendering engine 133 may update and/or configure template 264 with the view of the elements in the UI layout. Template 264 may be processed by looping through the dynamic elements to add each element to template 264 by dynamic UI rendering engine 133. Template 264, once updated and configured, may be retrieved and/or accessed by dynamic UI rendering engine 133, which may return template 264 to controller 250 for rendering and/or use. Template 264, once returned, may therefore include a layout of elements displayable in a UI that may simplify the merchant onboarding experience based on known and available data, thereby reducing the necessary data collection and inputs by a user performing the onboarding for the merchant.

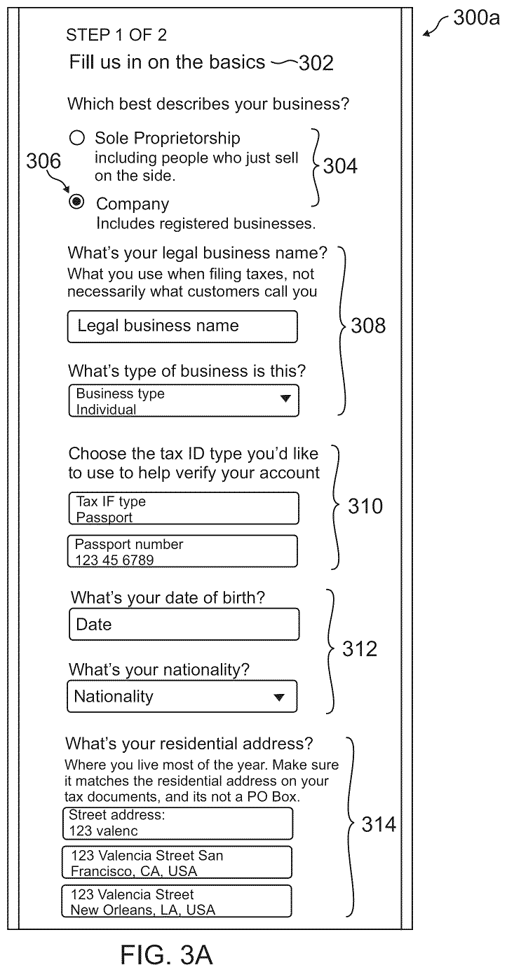

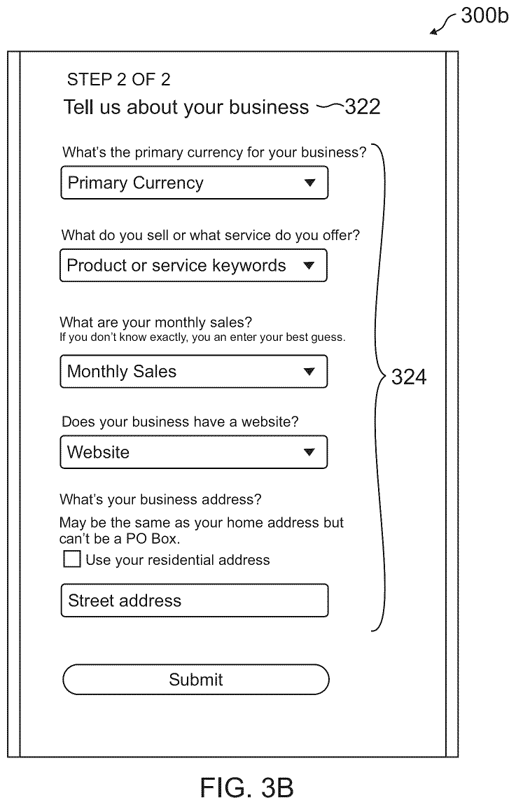

FIGS. 3A and 3B are exemplary user interfaces 300a and 300b dynamically configured for a merchant based on known and available data with rules for data acquisition and verification, according to various embodiments. User interfaces 300a and 300b may be presented to a user on a user device, such as onboarding interfaces 113 on client device 110 in system 100 of FIG. 1. User interfaces 300a and 300b may be displayed responsive to dynamic generation and rendering of interface elements by onboarding platform 130 of service provider server 120 for onboarding of a merchant and/or user. As such, user interfaces 300a and 300b may include a customization of UI elements and onboarding experiences based on available data and rules for data acquisition and onboarding.

Referring now to user interface 300a of FIG. 3A, user interface 300a may be generated by dynamic UI rendering engine 133 as previously discussed, and may be presented in order to streamline and simplify an onboarding process, removing the need for duplicate data entry and processing, as well as handling of unnecessary data and risk, trust, or authorization requests and decisions. In this regard, a user, such as an employee, owner, or the like of a merchant or an individual customer, may view an information acquisition form 302 for an onboarding process that has been specifically tailored and designed for the particular merchant and/or user accessing the onboarding process and viewing user interface 300a. For example, a business description request 304 is first shown to the user and may be preselected with a business description selection 306 of the type of business of the merchant. Business description selection 306 may be preselected and prefilled based on known information for the merchant, such as a previous business description, business or company documents, tax documents, and the like.

In user interface 300a, additional information that is required by one or more policies of the service provider may be requested in addition to the known information for the user to iterate through and process the onboarding of the merchant and/or user. For example, a legal business name and business type 308 may be requested and required for entry based on policies for onboarding and/or product verification and provision. A tax identifier type and number 310 may be prefilled from previously provided information and may be shown to the merchant for view and confirmation. Personal information 312 may also be requested in some embodiments where provision of the product that the merchant and/or user is onboarding for may require certain personal information (e.g., birthday, nationality, etc.) needed for onboarding, such as underwriting, verification, identity authentication, etc. Lastly, an address 314 may be entered and/or may allow for selection of known or historical addresses based on available data and policies for verifying address 314 during onboarding.

Referring now to user interface 300b, an advancement or further iteration of the onboarding flow is shown where the onboarding process iterates through a next dynamic UI presentation and UI element configuration in a layout so that a next portion of data may be acquired from the merchant and/or user for onboarding. In user interface 300b, additional business information 322 is requested based on the policies for onboarding and/or provision of the product that the user in onboarding for via user interfaces 300a and 300b. Additional business information 322 may be required in order to verify the merchant and/or authorize onboarding and may be specifically requested via UI elements dynamically configured in user interface 300b. As such, the merchant may proceed through mandatory business input fields 324 where the merchant and/or user may provide the requisite information or confirmed prefilled information to verify onboarding.

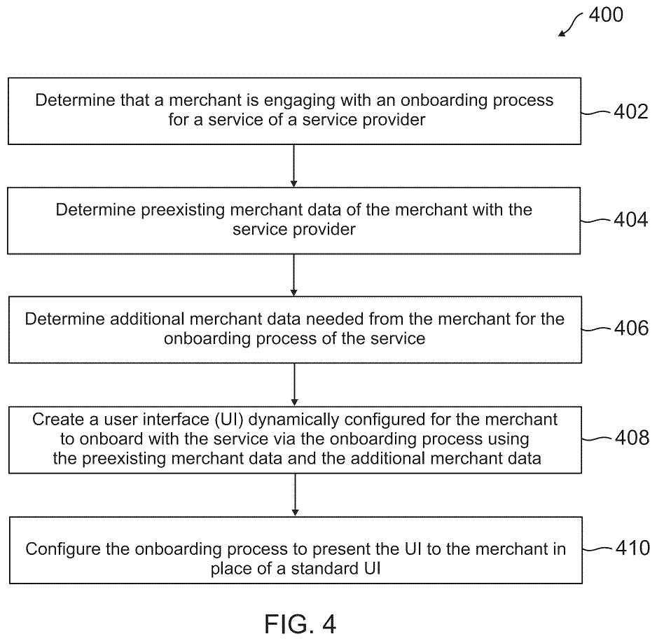

FIG. 4 is a flowchart 400 for a dynamic user interface rendering engine for personalized data acquisition using intelligently created rules, according to an embodiment. Note that one or more steps, processes, and methods described herein of flowchart 400 may be omitted, performed in a different sequence, or combined as desired or appropriate.

At step 402 of flowchart 400, it is determined that a merchant is engaging with an onboarding process for a service of a service provider. For example, in system 100 of FIG. 1, client device 110 may be used to engage in an onboarding for an account and/or use of a computing service provided by service provider server 120 through service application 122 or other products and platforms of service provider server 120. Detection of the onboarding may occur when the merchant initiates a sign-up or request for establishment of an account and/or use of a computing service or may occur after the merchant account is activated and used where the merchant may request use of further services from service provider server 120, such as through an account establishment process. In some embodiments, an offer for a computing service or other product provided by a service provider corresponding to service provider server 120 may be determined based on a trust profile, risk analysis, trusted merchant status, or the like, and an onboarding process may be provided to the merchant for one of onboarding experiences 131. However, to prevent unnecessary data entry and processing, UIs 132 of onboarding experiences 131 may be dynamically created, configured, and/or rendered based on available data 134 and/or UI rules 136. As such, a customized and personalized version of one of onboarding experiences 131 may be provided through onboarding processes 124 for onboarding of the user using created UIs 137.

At step 404, preexisting merchant data of the merchant with the service provider may be determined. In this regard, onboarding platform 130 may, in response to detecting client device 110 being offered and/or engaging with one or more of onboarding processes 124 for onboarding experiences 131, determine available data 134 for the merchant that may have previously been received and/or acquired. Client device 110 may correspond to a user of the merchant, and the user may have previously entered merchant data. However, merchant data may also be received and/or collected through other means, such as from different platforms, past histories and/or activities of the merchant, and the like. The preexisting merchant data may also include determined and/or computing data, such as a risk analysis, trust rating and/or profile, and/or status (e.g., trusted merchant).

As such, the merchant data may be received and/or collected from client device 110 and/or for the merchant from other systems and activities. This may include merchant sales, business, company, customer, or other information, as well as past activities of the merchant that may be associated with the merchant's business or sales. For example, the preexisting merchant data may include information about the merchant's business size, value, category, customers, products or services for sale, size or volume of transactions and payments, geographic location, and the like. Further, preexisting merchant data may past and/or current activities and/or interactions, including transaction histories, risk analysis and/or trust profiles, chat session dialogue or conversations with live agents or chatbots, and/or previous uses of onboarding processes 124 and/or engagement with different ones of onboarding experiences 131 through onboarding processes 124 or other onboarding activities. As such, the preexisting merchant data may be monitored, aggregated, and/or tracked over different platforms and applications of service provider server 120 that the merchant and/or similar merchants use.

At step 406, additional merchant data needed from the merchant for the onboarding process of the service. The additional merchant data may correspond to the same or similar types of data as the preexisting merchant data, but may not have yet been acquired by the service provider for onboarding and/or may be required to be reentered, confirmed, and/or validated based on data acquisition, onboarding, and/or service provision policies. In this regard, policies and procedures of the service provider may require certain data to be acquired for onboarding of merchants, and may also authorize use of preexisting data for other data used during and/or for the onboarding. For example, policies may be associated with laws, rules, or regulations for certain products and/or computing services including underwriting, data privacy, consumer protection, and the like. Policies may also be associated with risk models and/or fraud systems. Policies may be stored to a repository or other database and accessible for rule synthesis.

In this regard, rule processor 135 may synthesize and create rules intelligently using an AI engine, such as through execution of one or more ML models including LLMs to create rules that govern or control UI element presentations in UIs and their dynamic usage in UIs for data acquisition. As such, when one of onboarding experiences 131 is to be utilized to provide a UX for a merchant onboarding, the required data for onboarding of the merchant may be determined, and preexisting merchant data may be used to eliminate data acquisition UI elements and processes that do not need to be used and/or performed based on UI rules 136. However, the additional merchant data may be required by the rules and/or policies, and as such, that data may be required to be obtained through an iterative onboarding process through created UIs 137.

At step 408, a UI is created that is dynamically configured for the merchant to onboard with the service via the onboarding process using the preexisting merchant data and the additional merchant data. Once the additional merchant data is determined, UI rules 136 may be used to determine a set of UI elements, such as menus, fields, information, options, navigations, and the like, may be determined that may be used for data acquisition and onboarding in compliance with the policies and procedures of the service provider. To do so, an AI engine of and/or used by dynamic UI rendering engine 133 may dynamically create and/or configure layouts and presentations of UI elements in UIs 132 using the set of UI elements to output and/or render created UIs 137 on client device 110 during onboarding processes 124. The AI engine may generate layouts of the UI elements in created UIs 137 to present the UI elements in an efficient and coherent manner as they may appear during the corresponding one of onboarding experiences 131 so that a UX and data processing flow remains intact, which UIs 132 and customized to minimize data reentry and/or wasted time by the merchant during onboarding. Further, available data 134 that had previously been provided and/or available for the onboarding may be preloaded and/or inserted to created UIs 137 for merchant review and/or confirmation, such as with a request for the merchant to review and determine the accuracy and completeness of the data (e.g., if any data has changed, been updated, or otherwise needs reentry).

At step 410, the onboarding process is configured to present the UI to the merchant in place of a standard UL. In this regard, created UIs 137 may be used to specifically configure onboarding experiences 131, such as by updating UIs 132 and/or changing UI presentation using created UIs 137 for iterative data entry, acquisition, and processing for onboarding of the merchant. As such, when client device 110 accesses onboarding processes 124 for their specific onboarding UX, one or more of created UIs 137 may display the merchant-specific UIs and onboarding process that the merchant may engage in for onboarding for the merchant. Client device 110 may then view onboarding interfaces 113 and may provide merchant data 114. In some embodiments, onboarding interfaces 113 may include preloaded or prefilled portions of merchant data 114 with requests to confirm, as well as fields, options, and the like to provide needed portions of merchant data 114 for data acquisition and processing during merchant onboarding. As such, a user (e.g., an employee, owner, etc. of the merchant) may iteratively input, proceed through, and provide portions of merchant data 114 for merchant onboarding. Note that while flowchart 400 is described with respect to a merchant onboarding with merchant data, similar concepts, as discussed herein, can be used for configuring an onboarding process for a customer or end user, such as an individual.

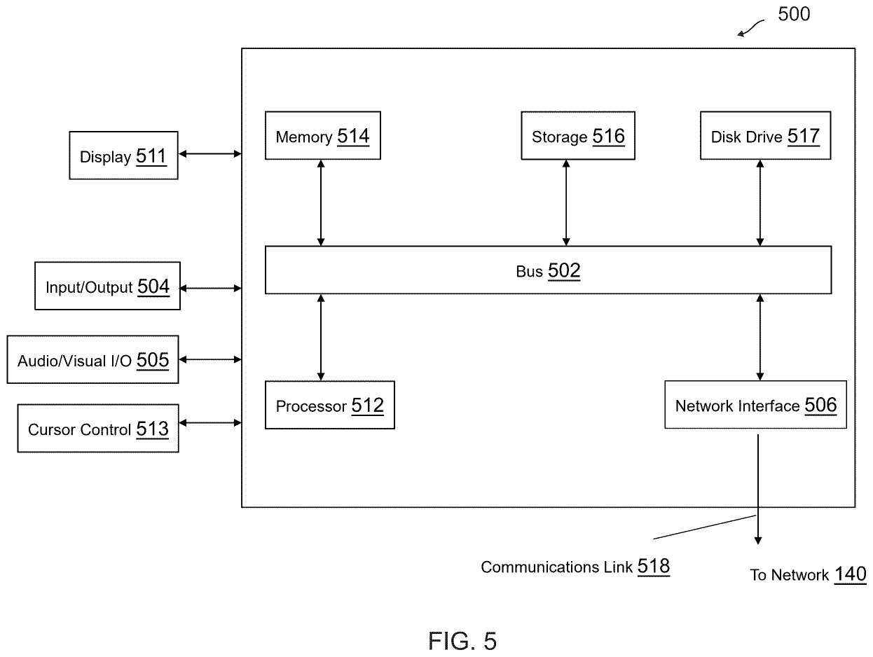

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to execute instructions to cause the service provider system to:
identify a merchant device associated with a merchant accessing an onboarding process that acquires merchant data for onboarding of the merchant for a service associated with the service provider system;
determine at least a portion of the merchant data available to the service provider system to initiate a first portion of the onboarding process for the service on behalf of the merchant;
determine additional merchant data needed for onboarding the merchant for the service during the onboarding process based on the at least the portion of the merchant data and a plurality of rules associated with data collection requirements for at least the onboarding process for the service;
identify one or more user interface (UI) elements utilizable to obtain the additional data from the merchant to satisfy the data collection requirements;
create a UI for a next portion of the onboarding process based on the one or more UI elements and using a UI rendering engine, wherein a UI layout of the UI is dynamically rendered by the UI rendering engine from a template UI layout based at least one the one or more UI elements and the data collection requirements; and
output the UI on the merchant device during the onboarding process.

2. The service provider system of claim 1, wherein executing the instructions further causes the service provider system to:
access a plurality of policies associated with the data collection requirements from a policy repository for the service provider system, wherein the policy repository manages the plurality of policies based on a plurality of services available for onboarding and data variables used for merchant authorizations of the plurality of services; and
generate the plurality of rules using the plurality of policies and an artificial intelligence (AI) engine, wherein the AI engine comprises at least one AI model trained based on the data variables and merchant behaviors of past merchants authorized for the plurality of services.

3. The service provider system of claim 2, wherein the plurality of policies comprises at least one of a risk management policy, a product usage policy, or a legal compliance policy.

4. The service provider system of claim 1, wherein executing the instructions further causes the service provider system to:
determine a presentation of the one or more UI elements to the merchant based on one or more merchant characteristics of the merchant, wherein the presentation configures output of each of the one or more UI elements in the UI,
wherein the UI is further created based on the presentation.

5. The service provider system of claim 4, wherein the UI rendering engine specifically renders the UI in the presentation in real-time when the merchant engages with the onboarding process.

6. The service provider system of claim 1, wherein the onboarding comprises one of an account establishment process for a merchant account or an enrollment process for a product offered to the merchant.

7. The service provider system of claim 1, wherein the UI rendering engine comprises one or more AI models configured to predict UI layouts for merchants based on the data collection requirements and historical value information for merchant accounts of the merchants.

8. The service provider system of claim 1, wherein the service comprises a product available to the merchant based on a trust profile of the merchant, and wherein the onboarding process is extended to the merchant based on a change of at least one merchant characteristic of the merchant that is associated with the trust profile.

9. The service provider system of claim 8, wherein, prior to identifying the merchant device accessing the onboarding process, executing the instructions further causes the system to:
determine that the merchant is a trusted merchant based on a risk analysis of the merchant;
identify the product based on the merchant being the trusted merchant; and
preload the at least the portion of the merchant data for the onboarding process based on at least one of previous merchant input by the merchant or historical information of the merchant with the service provider system for past usages of different services.

10. A method comprising:
detecting that a computing device is accessing an onboarding process that requires data for onboarding of an entity with a service provided by a service provider, wherein the computing device is authorized to perform the onboarding process on behalf of the entity;
determining that a first subset of the data is available to the service provider for the onboarding process without requiring input from the computing device;
determining a second subset of the data utilizable to advance the onboarding process for the entity with the service based on the first subset of the entity data and a rule for data collection required by the onboarding process and one or more policies of the service provider;
identifying a first set of customizable user interface (UI) elements for a UI that is utilizable to perform the data collection required by the rule based on the second subset of the data and a plurality of customizable UI elements of a UI rendering engine that dynamically renders different UI layouts of the UI;
generating a UI layout of the UI based on the first set of customizable UI elements and using the UI rendering engine, wherein the UI rendering engine renders the UI layout dynamically in the UI during the onboarding process; and
causing the UI having the generated UI layout to be output on the computing device during the onboarding process.

11. The method of claim 10, further comprising:
accessing the one or more policies of the service provider, wherein the one or more policies are associated with one or more requirements for data acquisition during the onboarding process; and
creating the rule based on the one or more policies.

12. The method of claim 11, wherein the rule is created using an artificial intelligence (AI) engine trained to synthesize rules for UI element selection for the one or more requirements for data acquisition, and wherein the AI engine implements the rule with at least one AI model utilized for the generating the UI layout.

13. The method of claim 10, wherein the onboarding process is offered to the entity prior to the detecting based on one or more characteristics of the entity.

14. The method of claim 13, wherein the one or more characteristics are associated with at least one of a trust profile for the entity or a business of the entity.

15. The method of claim 10, wherein the generating the UI layout includes automatically entering at least a portion of the first subset of the data to the UI with a request for a confirmation by the entity in a second set of customizable UI elements.

16. A non-transitory machine-readable medium having stored thereon machine-readable instructions executable to cause a machine to perform operations comprising:
determining an offer to a merchant of a computing service of an online service provider;
determining an onboarding process for the computing service, wherein the onboarding process includes a first user interface (UI) utilizable to acquire data for onboarding with the computing service, and wherein the first UI is customizable based on a plurality of UI elements to acquire different portions of the data;
identifying preexisting data of the merchant available to the online service provider to process a first portion of the onboarding process;
determining additional data of the merchant utilizable to process a next portion of the onboarding process;
generating a customization of the first UI based on the preexisting data and one or more of the plurality of UI elements to acquire the additional data;
detecting a computing device of the merchant requesting to access the offer; and
rendering the customization of the first UI dynamically on the computing device during the onboarding process.

17. The non-transitory machine-readable medium of claim 16, wherein, prior to the determining the offer, the operations further comprise:
performing a risk analysis of the merchant using a trust model; and
building a trust profile for the merchant based at least on the risk analysis,
wherein the offer is determined based on the trust profile.

18. The non-transitory machine-readable medium of claim 16, wherein the operations further comprise:
advancing between the first UI and a second UI during a progression of the onboarding process, wherein the second UI is further utilizable to acquire one or more portions of the additional data.

19. The non-transitory machine-readable medium of claim 16, wherein the computing service comprises a product available to the merchant based on one or more merchant characteristics of the merchant.

20. The non-transitory machine-readable medium of claim 16, wherein the first UI comprises the one or more of the plurality of UI elements for acquiring the additional data and at least a portion of the preexisting data automatically entered in at least one other UI element of the plurality of UI elements, wherein the at least one other UI element is utilized during the onboarding process for the computing service.
